(19) United States
(12) Patent Application Publication
(10) Pub. No.: US 2004/0007635 A1
(43) Pub. Date: Jan. 15, 2004

(54) Flue gas desulfurization grinding system

(76) Inventors: Daniel J. Quay, Slatington, PA (US); Mark D. Solomon, Bethlehem, PA (US); Russel W. Steffy, Fredericksburg, PA (US)

Correspondence Address: Daniel DeJoseph, F.L. Smith Inc., 2040 Avenue C, Bethlehem, PA, 18017-2188, US

(21) Appl. No.: 10/194,624

(22) Filed: Jul. 12, 2002

(51) Int. Cl. B02C 19/12

(52) U.S. Cl. 241/80

(57) ABSTRACT

The invention relates to a grinding circuit for use in a flue gas desulfurization system. The circuit comprises a mill for grinding limestone in water to form a limestone particle slurry. The thus-formed slurry is pumped to a hydrocyclone classifier which separates the limestone slurry into a slurry containing oversized particles that are to be reground in the mill and a slurry containing particles suitable for product which are sent to a product tank inlet for subsequent use in the flue gas desulfurization system. In the present system, the hydrocyclone classifier is elevated above the feed inlet into the mill but below the product tank inlet and, consequently, while the oversized particles are directed by gravity from the hydrocyclone to the mill feed inlet, the particles suitable for use in the flue gas desulfurization system are pumped from the hydrocyclone outlet to the product tank inlet.

The present invention describes a modification to a flue gas desulfurization grinding system. The invention provides for delivering the limestone particle slurry product from a hydrocyclone classifier to the slurry product storage tank by a means other than gravity. The process system modification uses a pump, in lieu of gravity and, optionally, a surge tank without agitation.

### BACKGROUND OF THE INVENTION

Air pollution legislation such as The Clean Air Act of 1963, The Air Quality Act of 1967, and The Clean Air Act Amendments of 1990 address numerous air quality problems in the U.S. One of these problems is acid rain caused by sulfur dioxide and nitrogen oxide emissions from fossil-fueled power plants and other industrial and transportation sources. Sulfur oxides and nitrogen oxides are recognized as harmful pollutants and there are ongoing efforts to remove these toxic gases. Under emission regulatory requirements and legislation to reduce the emission of these air pollutants, power plants in particular have installed “flue gas desulfurization systems”, also known as scrubbers. Wet flue gas desulfurization or scrubber systems are an excellent way of reducing the sulfur dioxide emissions caused by coal or other fossil fuel fired combustion boilers. The flue gas discharged from the boiler is fed into the absorber or scrubber. In the absorber, a slurry of water and pulverized limestone is sprayed on the sulfur laden flue gas. The chemical reaction between the limestone slurry and sulfur gas results in a solid sulfur byproduct instead of the more harmful sulfur dioxide gas.

Typically and most economically and conveniently, in such flue gas desulfurization pulverized limestone slurry is produced on site in a separate limestone grinding circuit. In the process, limestone is pulverized, typically in a ball mill, mixed with water to form a slurry, and then sent to a classifier, where larger (typically above about 45 micron) sized limestone pieces are recycled to the inlet of the mill to be reground. Prior art processes reflect the thinking that the most energy efficient solution is to direct the oversized limestone pieces and the suitably sized product, to the inlet of the, respectively, mill and product tank by gravity feed.

Such grinding circuits consume a significant amount of energy, and improvements in the apparatus and/or process that would reduce energy consumption are always desirable. The present invention achieves energy savings in a counterintuitive fashion, by replacing a gravity feed into the product tank with an additional slurry pump. The present invention has the additional advantage of reducing the overall height of the limestone grinding circuit.

### DESCRIPTION OF THE DRAWINGS

FIG. 1 is a schematic drawing of a prior art flue gas desulfurization (FGD) grinding circuit.

FIG. 2 is a schematic drawing of one embodiment of a FGD grinding circuit of the present invention.

The drawings are not drawn to scale. Like numerals in both drawings refer to similar elements.

### DESCRIPTION OF THE INVENTION

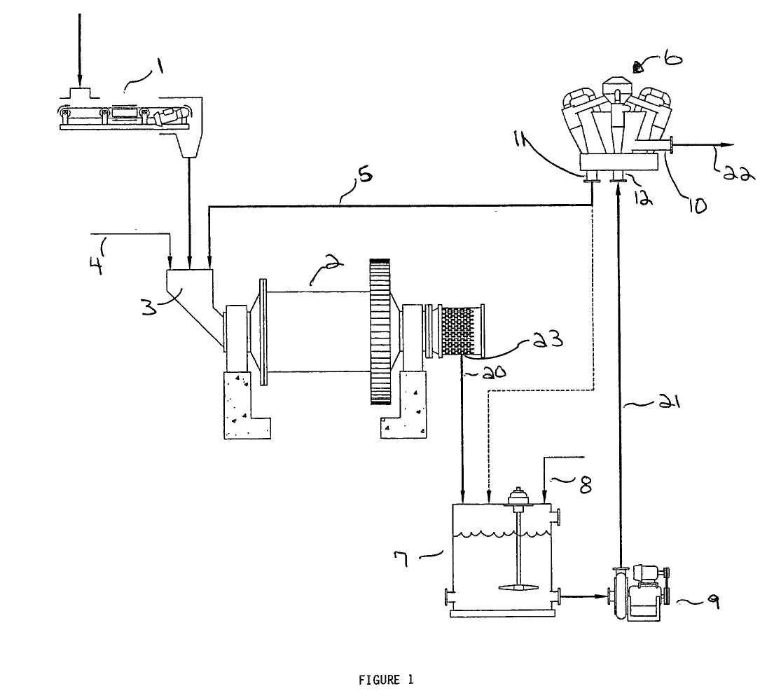

The prior art FGD grinding circuit set forth in FIG. 1 functions as follows: First, the raw feed (limestone) enters weighfeeder 1 which is interlocked with a control system (not shown) and controls the flow of the raw limestone feed into ball mill 2. Weighfeeder 1 discharges the raw limestone into feed chute 3 of mill 2. Make-up water is also added to feed chute via piping 4. The limestone is ground in ball mill 2 in the presence of water into a limestone particle slurry. The ground limestone slurry is discharged from ball mill 2 via slurry outlet 23 and flows by gravity into slurry sump tank 7 via chute 20. In tank 7 the limestone slurry is diluted with water delivered via water pipe 8, agitated and then pumped from sump tank 7 to hydrocyclone classifier inlet 12 by slurry pump 9 via pipe 21. Limestone slurry delivered from sump tank 7 generally contains about 50% solids.

Hydrocyclone 6 classifies the limestone slurry. Limestone particles over 45 microns are typically considered too large to be effective SO₂ absorbers and are returned to the mill for further grinding. The elevation of hydrocyclone 6 is determined such that both the underflow (oversized material that is returned to mill 2 via pipe 5 is designated as cyclone underflow) and overflow (undersized particles that are delivered to product storage tank inlet (not shown) via pipe 22 are known as the cyclone overflow) can be delivered to the mill feed chute 3 and the product tank inlet, respectively, by gravity induced flow. This of course requires that product outlet 10 and underflow outlet 11 of hydrocyclone 6 be located sufficiently higher than the product tank inlet and mill feed chute 3, respectively. This also requires enough pump power to move the limestone slurry from the slurry sump tank 7 to the hydrocyclone inlet 12. In typically sized FGD systems the limestone slurry product tanks are about 50 feet high. In such tanks the limestone slurry product is introduced into the top of the tanks, in order to provide for complete tank storage and equal distribution. Therefore, in order to have gravity flow of limestone slurry into the product tank, hydrocyclone 6, at considerable expense, has to be raised above the product tank, with the actual height of hydrocyclone 6 being determined by the plant layout and the desired product flow rate from the hydrocyclone. In addition to the expense of raising hydrocyclone 6, slurry pump 9 has to be sized to raise an approximately 50% solids limestone slurry more than 50 feet.

Cyclone underflow is an approximately 70% solids slurry that contains larger sized rejects from hydrocyclone 6. Such a slurry is not advantageously pumped because of its wear characteristics and therefore it is gravity fed into raw mill inlet 3. Cyclone overflow sent to product typically is an approximately 30% solids slurry.

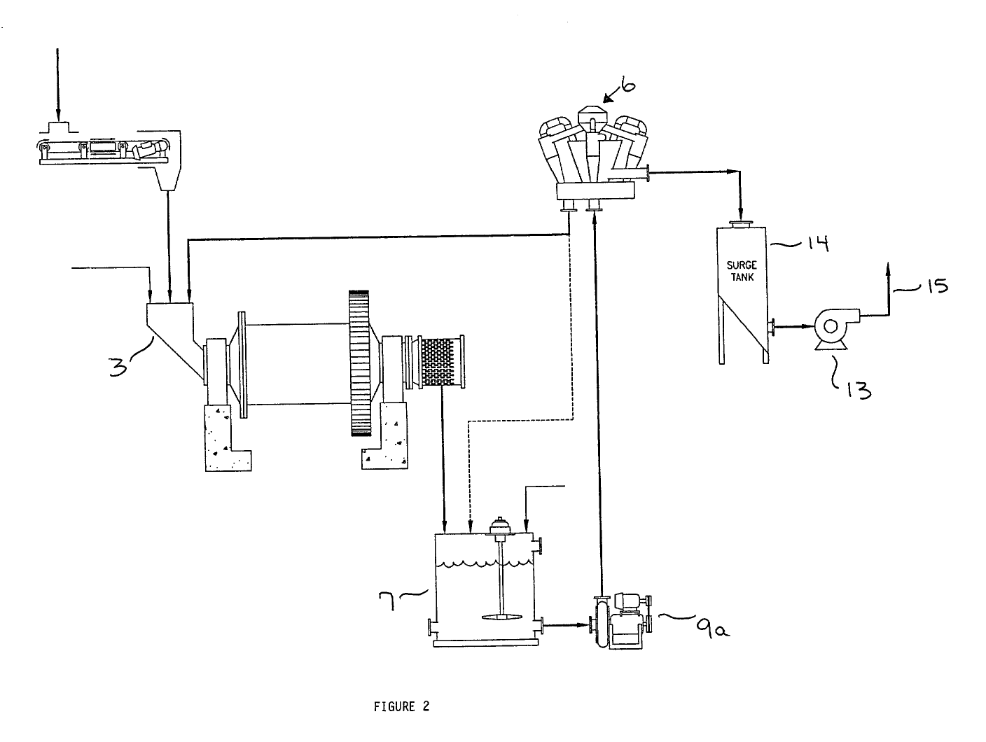

The FGD grinding circuit of the present invention set forth in FIG. 2 has significant differences from the prior art system. Hydrocyclone 6 is still positioned such that cyclone underflow may flow back to the mill feed chute 3 via gravity. However, unlike prior art systems hydrocyclone 6 is positioned beneath the product tank inlet and therefore the cyclone overflow has to be delivered to the product tank inlet via a second pump 13 via pipe 15. Pump 13 can either draw directly from hydrocyclone's underflow launder, assuming it is sufficiently sized, or it may draw from an optional surge tank 14 which functions essentially as a reservoir and receives overflow from hydrocyclone 6. The surge tank 14 may be constructed of rubber lined carbon steel and does not require agitation.

In the FGD grinding system of the present invention, hydrocyclone classifier 6 is positioned approximately 20 to 40 feet below where it is positioned in the standard FGD grinding circuit. Because the hydrocyclone is located at a lower elevation in the modified grinding circuit, slurry pump 9a utilizes significantly less power to raise the slurry from the slurry sump tank 7 to hydrocyclone inlet 12. It has been surprisingly discovered that the overall combined power needs of the slurry sump pump 9a and the second slurry pump 13 is equal to 75% of the required pumping power of slurry sump pump 9 of the standard prior art FGD grinding circuit. Further, because the hydrocyclone is at a lower elevation in the FGD grinding circuit of the present invention, there is also be a significant reduction in building height with associated savings.

The system modifications of the present invention may be used on any type of wet classification system in which there is a recirculation of a slurry containing oversized minerals from the classifier to the inlet of a means for grinding. Any suitable grinding means can be utilized that can grind the specific minerals in water to form a slurry, the specific size of particles suitable for product being determined on an application by application basis.

While there are shown and described present preferred embodiments of the invention, it is to be understood that the invention is not limited thereof, but may be otherwise variously embodied and practiced within the scope of the following claims.

What is claimed is:

1. A limestone slurry grinding circuit for a flue gas desulfurization system, said grinding circuit comprising
(a) a mill for grinding limestone in water to form a limestone particle slurry, said mill having a feed inlet and slurry outlet,
(b) means to direct the limestone particle slurry from the mill to a slurry sump tank in which the slurry is mixed with water and agitated,
(c) means to pump the limestone particle slurry from the slurry sump tank to a hydrocyclone classifier for separating the limestone particles into a first slurry containing oversized particles to be reground in the mill and a second slurry containing particles suitably sized for use in the flue gas desulfurization system, with said second slurry being directed to a product tank inlet, said hydrocyclone classifier being elevated above the mill feed inlet and being at a lower elevation than the product tank inlet,
(d) means to direct the oversized particles by gravity from the hydrocyclone to the mill feed inlet for regrinding, and
(e) pumping means to move the undersized particles upward from the hydrocyclone to the product tank inlet.

2. The limestone slurry grinding circuit of claim 1 wherein the oversized particles are greater than 45 microns.

3. The limestone slurry grinding circuit of claim 1 wherein the first slurry is an approximately 70% solids slurry.

4. The limestone slurry grinding circuit of claim 1 wherein the second slurry is an approximately 30% solids slurry.

5. A grinding circuit comprising
(a) means for grinding a mineral in water to form a mineral particle slurry, said grinding means having a feed inlet and a slurry outlet,
(b) means to direct a particle slurry from the grinding means to a hydrocyclone classifier for separating the mineral particles into a first slurry containing oversized particles to be reground and a second slurry containing particles suitable for sending to a product storage means having an inlet, said hydrocyclone classifier being elevated above the inlet to the grinding means and at a lower elevation than the inlet to the product storage means,
(c) means to direct the first slurry by gravity from the hydrocyclone to the grinding means feed inlet, and
(d) means to move the second slurry independent of gravity upward from the hydrocyclone to the inlet to the product storage means.
